(19) United States
(12) Patent Application Publication
(10) Pub. No.: US 2007/0184820 A1
(43) Pub. Date: Aug. 9, 2007

(54) System and method for delivering content

(76) Inventor: Richard Marshall, Edinburgh (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/367,764

(22) Filed: Mar. 3, 2006

(30) Foreign Application Priority Data
Feb. 8, 2006 (GB) 0602562.1

(51) Int. Cl. H04Q 7/22

(52) U.S. Cl. 455/414.3

(57) ABSTRACT

A system for implementing a method for selection, delivery and display of precisely targeted advertisements to mobile phones or devices operates on computers that serve the content and on the mobiles phones and devices. Many people use their mobile phones to browse information, the providers of which desire to display advertisements. However users will not accept any inconvenience or additional delay. The present invention allows for very precise targeting of advertisements to the user by scoring how closely they match the interests of the user. The invention also provides a method for transmitting the advertisement to the device without introducing delay to the transmission process. The invention then displays the advert during time when the user is waiting for new content, thus not interrupting their browsing.

### FIELD OF THE INVENTION

The present invention relates to the delivery of content to a mobile device, particularly but not exclusively to the precise targeting, delivery and display of advertisements on mobile devices.

### BACKGROUND

Mobile phones are now ubiquitous in many markets, providing voice, text and image messaging and internet browsing facilities. The limited browsing capabilities of early devices combined with a restricted range of content adapted for the screen size led to low uptake of mobile browsing. This trend is now being reversed, with an enormous increase in the number of mobile pages viewed, each viewing conventionally referred to as an impression.

Most mobile operators run some form of mobile portal, providing a wide range of content, including news, sports and entertainment to their users. Most operators also allow open access to the internet for access to mobile enabled-content from a wide range of providers.

Currently many web pages contain advertising. This advertising is typically targeted either on the basis of web page content, or web site affiliation, which does not provide precise matching to the needs of the user, as it cannot be sensitive to additional factors that may affect user interests, such as time of day or location of the user.

Due to the length of time it takes for a mobile phone to contact a server, request content and receive it, it is not practical or acceptable to users to incur additional delays to download advertisements or extra information.

### SUMMARY OF THE INVENTION

The present invention aims to address the above problems.

Embodiments of the invention aim to provide for selection, delivery and display of precisely targeted advertisements, or relevant supplementary information, to mobile phones and devices without inconveniencing the user. In addition, the advertiser may be charged according to the closeness of the match between the advertisement and the user's requirements.

According to an embodiment of the invention, there is provided a method of delivering targeted content to a mobile device, the method comprising receiving a request for content from a mobile device, the request being associated with at least one parameter, automatically selecting additional content in dependence on the at least one parameter and providing the additional content to the mobile device in addition to the requested content.

The method may further comprise selecting additional content in dependence on the requested content, for example analysing the requested content to determine at least one attribute and comparing the determined attribute with predetermined attributes of the additional content.

The determined attribute may comprise keywords, a location of the mobile device, a time at which the request is made, at least one parameter selected from a user profile associated with a user of the mobile device, or a plurality of parameters defining capabilities of the mobile device.

The method may comprise calculating a score for the additional content in dependence on the at least one parameter. The step of calculating a score may comprise incrementing the score when the at least one parameter matches a predetermined attribute associated with the additional content. For example, the score is incremented when a keyword in a content page matched a keyword associated with an advertisement, when the request time falls within a time band associated with the advertisement, when the location of the mobile device is within a predetermined distance from a location associated with the advertisement or when a user profile of the user of the mobile device matches with the user profile associated with the advertisement.

The method may comprise selecting the additional content based on the highest price that an advertiser is prepared to pay for the score.

The method may comprise selectively weighting the additional content based on a prior selection by a user of content of interest, for example in the form of brands included on a whitelist. The method may further or alternatively comprise excluding content from selection based on a prior selection by a user of excluded content, for example, in the form of brands listed on a blacklist.

The additional content may comprise a plurality of segments or pages of additional content, the method further comprising specifying the order in which the plurality of segments are to be displayed to the user, for example based on a rotation schedule, as well as specifying a presentation style for each segment or page of additional content.

According to another embodiment of the invention, there is provided a method of delivering content to a mobile device, the method comprising receiving a request for content to be displayed at the mobile device, selecting additional content to be sent to the mobile device with the requested content and providing the additional content to the mobile device immediately after the requested content.

The method may comprise displaying the requested content when it is received at the mobile device, and storing the additional content in the memory when it is received at the mobile device. The method may further comprise reading the stored content from the memory and displaying it when the mobile device sends a request for new content.

According to a further embodiment of the invention, there is provided a method of operating a mobile device, comprising requesting content from a remote content provider, determining if additional content is stored at the device and if additional content is stored at the device, displaying the additional content while waiting for the requested content to be delivered.

An advantage of this approach is that the user is not inconvenienced by any additional delays when additional content such as advertising is downloaded to his or her mobile device, and may have an enhanced viewing experience in that new information, entertainment or advertising is displayed while the user is waiting for requested content to download.

The additional content may comprise a plurality of advertisements, the advertisements being displayed in accordance with a rotation schedule specified by the advertiser.

Each advertisement may be associated with a URL, and the met hod may further comprise linking to the URL in response to a user action.

According to a further aspect of the invention, there is provided a system for delivering targeted content to a local content cache in a mobile device, the mobile device operating in a local context, the system comprising a server computer configured to rank a plurality of pages of additional content using weighting algorithms to determine relevance of each of the plurality of pages of additional content to the local context of the mobile device, the server computer being configured to deliver at least one page of additional content to the device for storage at the device, the page being ranked relatively highly in comparison to others of the plurality of pages and the mobile device being configured to store the at least one page of additional content in the local content cache.

The mobile device may be arranged to calculate the most relevant additional content for the local content cache based on local attributes.

According to a yet further aspect of the invention, there is provided a mobile device having a content cache, comprising a communications module configured to request content from a remote content provider, a content cache reading module configured to determine if additional content is stored at the device and a display driver, the display driver being configured, if additional content is stored at the device, to display content selected from the additional content while waiting for the requested content to be delivered.

### BRIEF DESCRIPTION OF THE DRAWINGS

Embodiments of the invention will now be described by way of example with reference to the accompanying drawings, in which:

FIG. 1 shows an overview of a content providing system according to an embodiment of the invention;

FIG. 2 is an overview of the arrangement of components within a mobile device that may be used in the system of FIG. 1 to access content;

FIG. 3 is a more detailed illustration of the content providing system shown in FIG. 1;

FIG. 4 is a flow diagram illustrating the process used by advertisers to log their advertisements with the system of FIG. 3;

FIG. 5 is a flow diagram illustrating the process of creating a new presentation for an advertisement according to the invention;

FIG. 6 is a flow diagram illustrating the overall operation of the system of FIG. 3;

FIG. 7 is a schematic diagram showing a series of content pages in accordance with an embodiment of the invention;

FIG. 8 is a flow diagram illustrating the process of displaying the content pages of FIG. 7 on a mobile device according to an embodiment of the invention;

FIG. 9 shows a timing diagram illustrating a conventional content download process;

FIG. 10 shows a timing diagram illustrating a content download process according to an embodiment of the invention;

FIG. 11 is a flow diagram illustrating the process of advert generation according to an embodiment of the invention; and

FIG. 12 is a flow diagram illustrating the process of advertisement weighting according to an embodiment of the invention.

### DETAILED DESCRIPTION

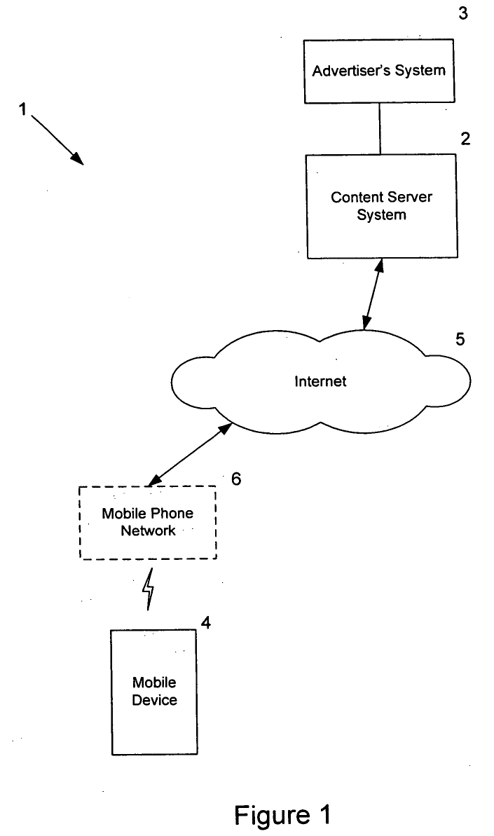

Referring to FIG. 1, a content providing system 1 according to an embodiment of the invention comprises a content server system 2, one or more advertiser's systems 3 and a mobile device 4 connected to the content server system 2 via the Internet 5 and a mobile phone network 6, for example a GPRS based network.

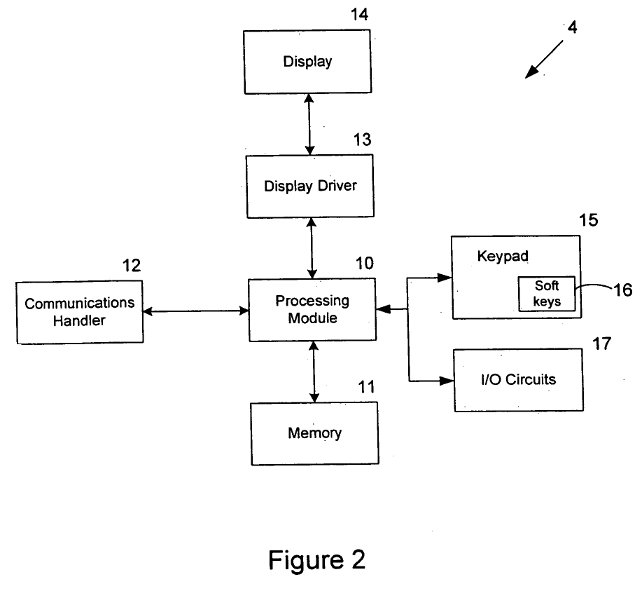

Referring to FIG. 2, the mobile device 4, such as a mobile telephone, PDA or the like, comprises a processing module 10, memory 11, also referred to herein as a cache, a communications handler 12 including circuitry for making and receiving phone and data calls, a display driver 13, a display 14, a keypad 15 including user-programmable soft keys 16 and other I/O circuits 17 required to implement device functionality, including microphone and speaker circuitry and so on. Mobile devices of many different types, including portable and hand-held devices, are well-known in the art and will not be described further in detail.

The content server system 2 comprises one or more computers as required to supply mobile content to mobile devices. The conventional configuration of such a server system as currently operated by mobile operators is well-known in the art and will not be described further in detail.

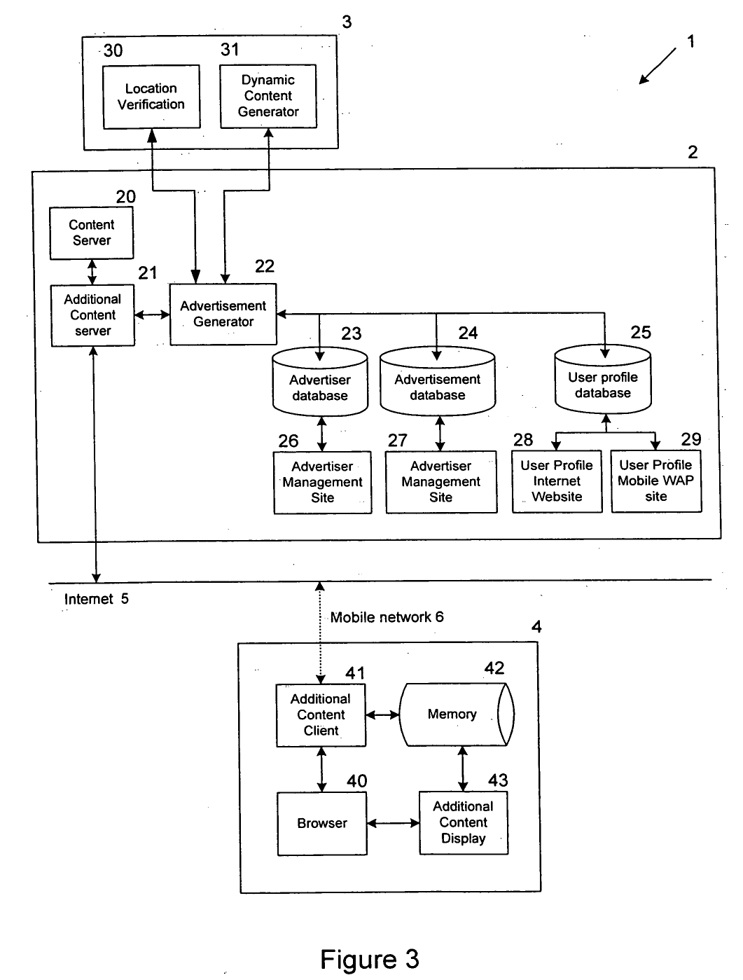

FIG. 3 illustrates the various software components for implementing a system according to an embodiment of the invention.

The content server system 2 includes a content server program 20 for providing content to the mobile device, such as news, entertainment services and so on, and an additional content server program 21 for providing additional content to the mobile device 4. In this example, the additional content comprises advertisement related content, and the additional content server program 21 is also referred to herein as the advertisement server program 21. However, the invention is not limited to the provision of advertisement related content and the provision of other types of content, such as supplementary information or entertainment, is also envisaged, including but not limited to promotional items such as film trailers.

In alternative embodiments, the additional content may comprise vouchers for use in locations associated with the advertiser. For example, the vouchers may be in the form of a displayable coupon or a displayable bar code that may be scanned in a shop or branch to entitle the user to a discount or other promotional offer.

The content server system 2 also includes an advertisement generator 22 connected to an advertiser database 23, an advertisement database 24 and a user profiles database 25. The advertiser database 23 and advertisement database 24 are respectively managed through an advertiser management site 26 and an advertisement management site 27 accessible via the Internet 5. The user profiles database 25 is similarly associated with a user profile Internet website 28 and a user profile mobile WAP site 29.

The user profile database 25 can be built up in one of two ways. The first is a record of keywords browsed to build a model of the interests of the mobile phone user in order to allow the system to refine the selection of advertisements. The second aspect of the profile allows individual mobile phone users to register their own interests, likes and dislikes. This registration will include, but is not limited to, keywords and brand identification. A mobile phone user will be able to use the Internet web site 28 or mobile WAP site 29, that will record selections in the user profile database 25.

In a further example of the invention, a user can add blacklist and whitelist keywords and brands to their user profile, permitting a user to opt never to see certain advertisements via a blacklist, or to select favourite brands and/or advertisements via a whitelist.

The advertisement generator 22 is optionally connected to a location verification module 30 and a dynamic content generator 31 in an advertiser's system 3.

The mobile device 4 includes a browser program 40, an additional content client program 41, a memory 42 for storing additional content and an additional content display program 43. In this example, the additional content refers to advertising content and the additional content client program is also referred to herein as the advertisement client program 41.

At present, information is sent to mobile devices 4 in the form of WAP or XHTML content, with additional information in the form of image, video and audio files in various formats. This information is provided by the content server program 20 and decoded for display on the device 4 by the browser program 40.

The advertisement generator program 22 according to an embodiment of the invention runs on the server 2 and generates advertising content. The advertisement client program 41 runs on the mobile device and receives the advertising content from the advertisement server program 21 via the Internet 5 and the mobile phone network 6.

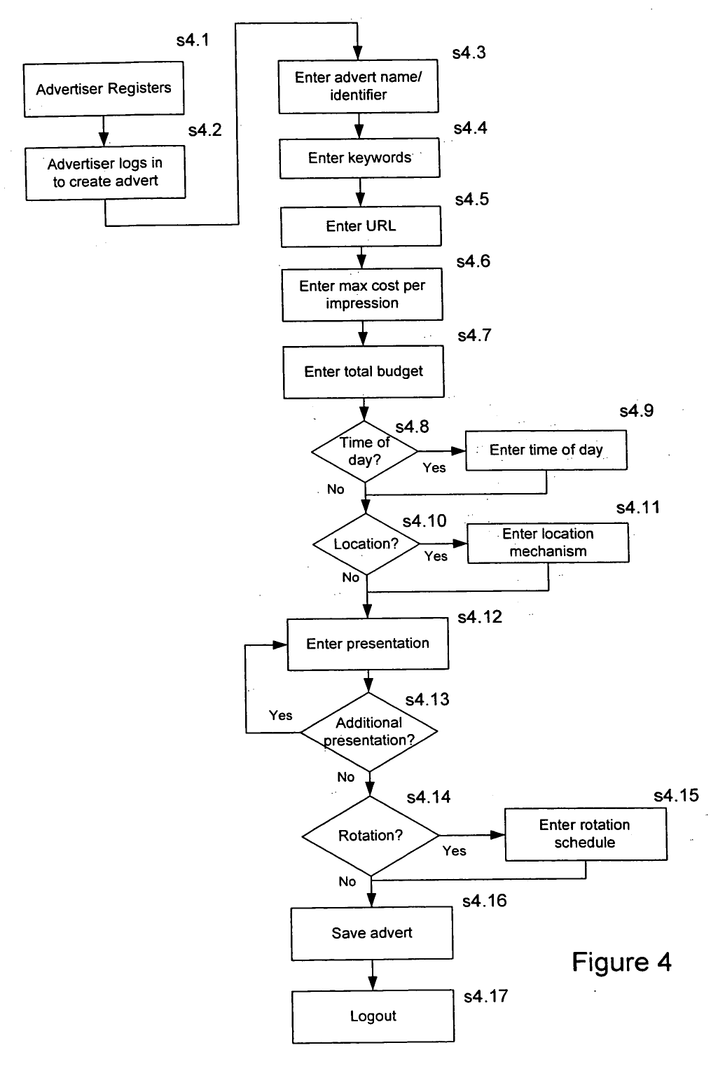

Referring to FIG. 4, before being able to login to the system, an advertiser first registers with the content server system through the advertiser management site (step s4.1), selecting a user name and password in a manner that is well known. To register, advertisers supply particular details, including, for example, company name, address and contact details, as well as details of payment methods, advertising budget and so on, all of which are stored in the advertiser database 23. Payment methods include, for example, monthly invoice or credit card details permitting direct charging.

Once an advertiser has registered, they can login to the system (step s4.2). The many different ways in which registration and login procedures can be carried out are well-known and will not be described in any further detail.

After registration and login, an advertiser may also register advertisements. This allows the advertiser to create a new advertisement as well as selecting and amending existing advertisements.

To create a new advertisement, the advertiser enters an advert name or identifier (step s4.3). He then enters keywords which will be used for comparison with keywords in a page selected by a user (step s4.4). Advertising keywords are specified as, for example, a list of text words. In addition to keywords, the advertiser may register with the content server system 2 a direct association between the advertisement and a page of information. This association is established by registering the page address with the advertisement. For example, a URL address may be registered with each advertisement (step s4.5). Viewing the content at this address will typically provide additional information on the product or service, including an opportunity to purchase it.

For each advertisement, the advertiser states how much they are prepared to pay per impression based on a score (step s4.6). The higher the score, the more the impression will cost. For example, an advertiser may state that he is prepared to pay 1 currency unit for each impression having a score of 10, 2 currency units for a score of 20 and five currency units for a score of 25 or above. The advertiser then enters their total budget, specifying the maximum amount they are prepared to spend in any given period (step s4.7).

If time of day information is to be associated with the advertisement (step s4.8), then the advertiser enters the particular time of day with which the advertisement is to be associated, which may be in hour ranges or by abstract keyword, for example, morning, afternoon and so on (step s4.9).

If location information is to be included (step s4.10), then the advertiser may define a mechanism 30 (step s4.11) that allows the advertisement generator 22 to query the advertisers' computer systems 3 as to the proximity of their branches or services to the approximate locality of the user. This mechanism includes, but is not limited to, web services conforming to an agreed format.

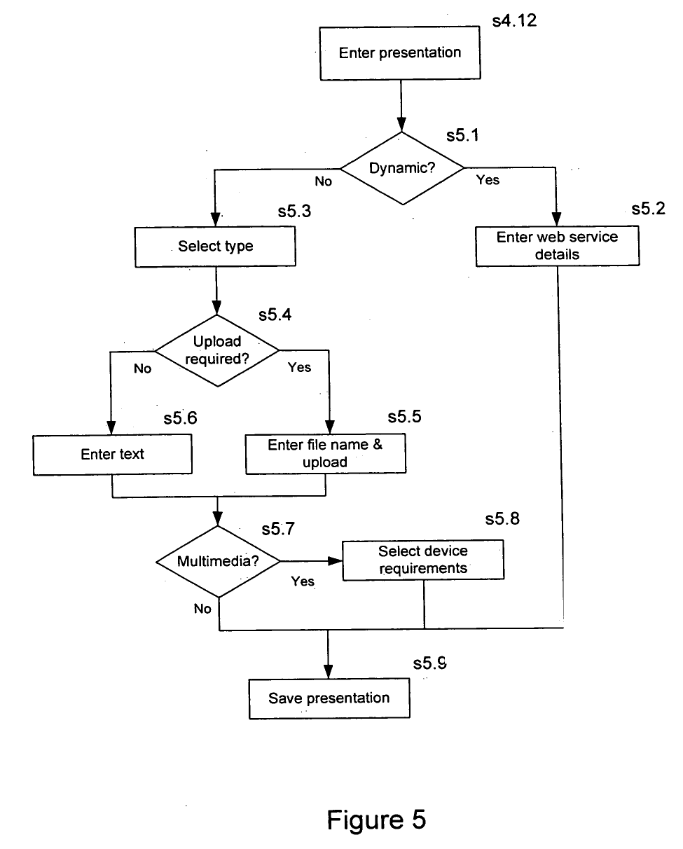

Each advertisement can include a selection of presentation styles, including but not limited to plain text, WAP files, raster graphics files in various formats and sizes, scalable vector graphics for rendering for the exact device, SMIL files, audio files, video files or composites of several formats. The advertiser therefore specifies one or more presentation styles (steps s4.12 & s4.13) as will be described in detail in relation to FIG. 5.

An advertiser may also specify a rotation schedule for an advertisement (steps s4.14 & s.4.15). This schedule specifies a number of different presentation styles, that are to be delivered in a rotating sequence. This sequence may cycle per mobile phone or by impression. This mechanism ensures that advertisements are more varied.

The advertisement is then saved to the advertisement database (step s4.16) and the advertiser can log out (step s4.17).

As mentioned above, functionality is also included to permit an advertiser to amend existing advertisements, by editing the features specified above, adding new presentations and so on.

FIG. 5 illustrates the process of registering an advertisement presentation.

The advertiser first selects whether the presentation should be dynamic or not (step s5.1). This allows for advertisements to be created specifically for the user, including references to keywords and locations. The mechanism may include, but is not limited to, web services conforming to an agreed format, a simple textual replacement language, or direct invocation of a computer program (step s5.2).

If the presentation is selected not to be dynamic, the advertiser then selects the style of presentation, for example, plain text, as mentioned above (step s5.3). If upload of a file is required (step s5.4), then the advertiser enters the file name and the file is uploaded (step s5.5). Otherwise, the advertiser enters the text to be displayed (step s5.6). If the presentation is a multimedia presentation (step s5.7), the advertiser specifies the device requirements to be able to run this presentation, for example, video and audio capability (step s5.8). The presentation is then saved to the advertisement database (step s5.9).

As with the advertiser database, functionality is also provided for an existing advertisement to be edited, which will not be described in detail further.

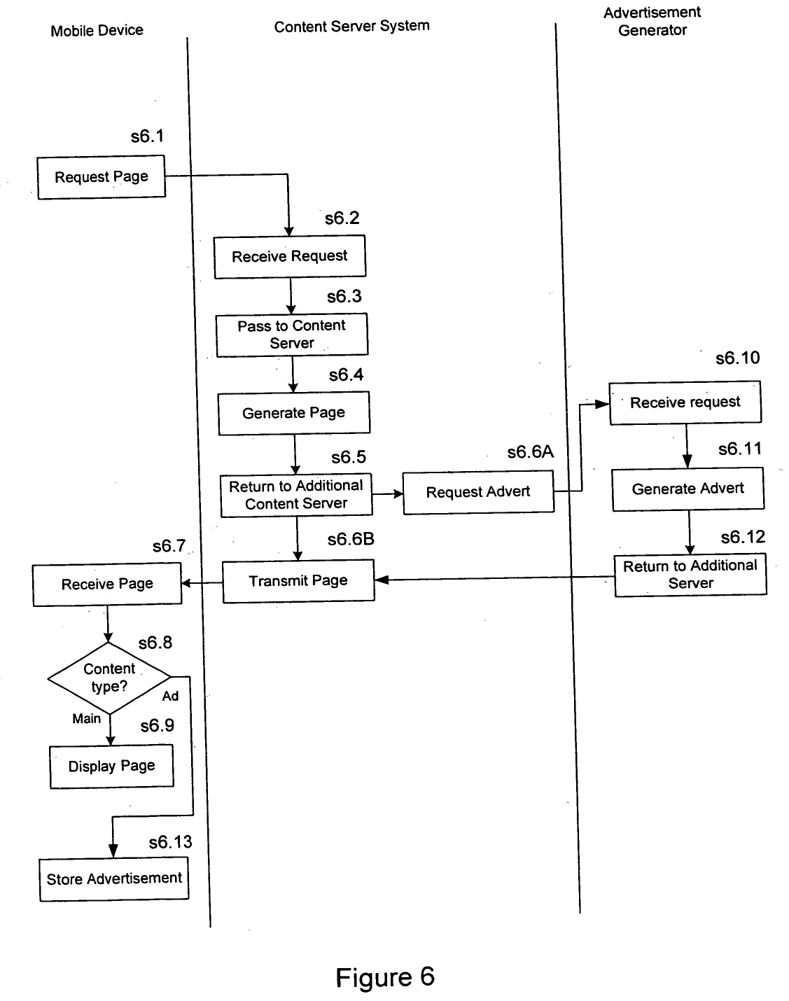

FIG. 6 illustrates the overall operation of the system according to the invention.

A user first requests a page of content (step s6.1), for example by selecting a link in a currently displayed page. This request is received by the additional content server program 21 (step s6.2), which passes the request for the page to the content server program 20 (step s6.3). The content server program 20 generates the requested page in a conventional way, based for example on stored pages, (step s6.4) and returns it to the additional content server program 21 (step s6.5). On receipt of the content, the additional information server program 21 sends a request for a suitable advertisement to the advertisement generator 22 (step s6.6A). At the same time, the additional information server program 21 also begins sending the content to the mobile device (step s6.6B). The additional content client program 41 running on the mobile device 4 receives the content (step s6.7) and determines the content type (step s6.8). Since the page transmitted is content for immediate display, also referred to herein as main content, the additional content client program 41 passes it to the browser program 40 for display in the usual way (step s6.9). A way of distinguishing main content from additional content will be described in detail below.

At the content server system 2, the advertisement generator 22 receives the request for the advertisement (step s6.10) and generates an appropriate advertisement in response (step s6.11). The primary purpose of the advertisement generator is to select the best targeted advertisement for that user, as will be explained in more detail below.

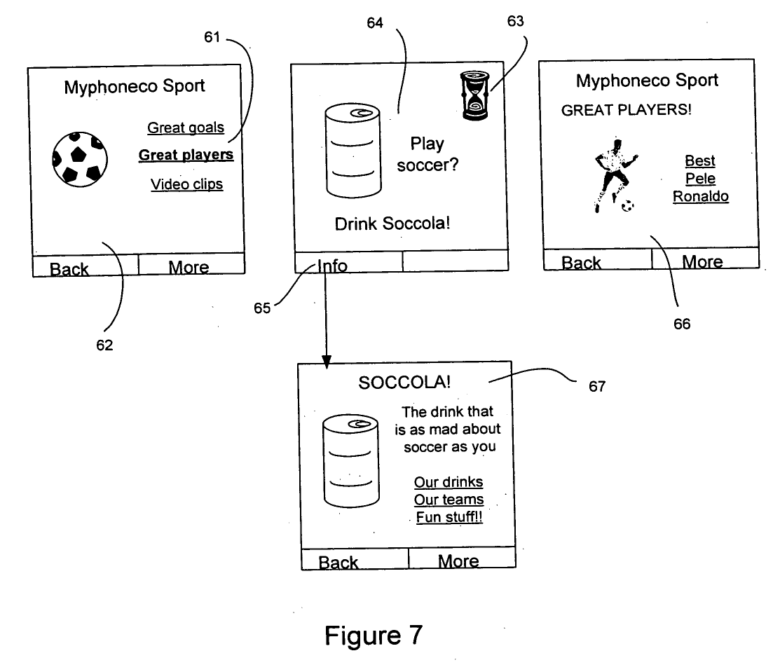

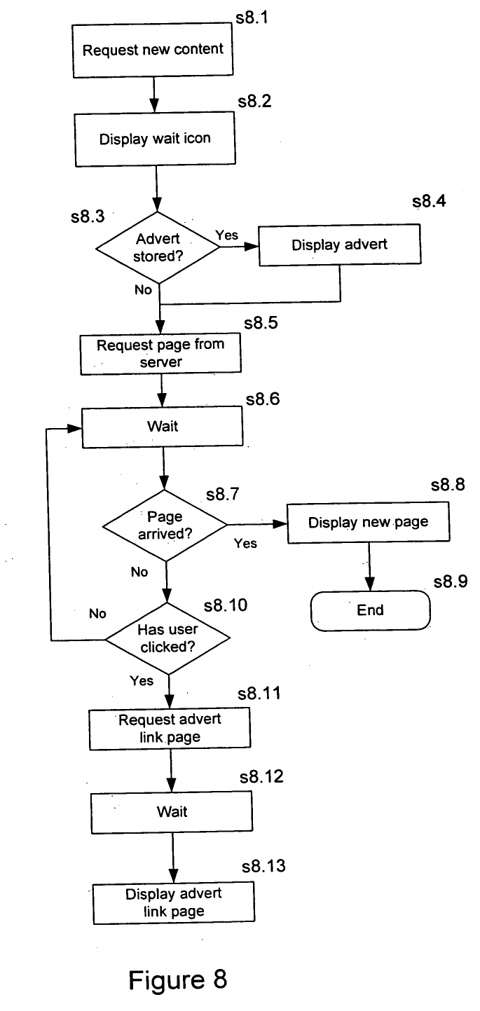

The advertisement is returned to the additional content server program 21 (step s6.12), which transmits it to the mobile device (step s6.6B) after the main content has been sent, as explained below in relation to FIGS. 7 and 8. The advertisement may be transmitted in any syntax or form that can be encoded by the server computer program and decoded by the mobile phone or device computer program.

This format may be text, WAP, XHTML, SMIL, graphics formats such as PNG, audio formats such as MP3, video formats such as 3GP or binary-encoded serialized programming objects. In addition, the advertisement is marked as additional content to ensure that the additional content client program 41 recognises it. For example, a data field in an identification packet is set to indicate this.

The additional content client program 41 receives the advertisement (step s6.7), and, at step s6.8, determines the content type to be additional content, which is stored in the memory 42 (step s6.13).

The operation of the mobile device 4 according to the invention is explained below with reference to FIGS. 7 and 8.

When a user requests a new content page, for example by selecting a link 61 in an existing page 62 (step s8.1), a wait icon 63 is displayed, such as an hourglass symbol, indicating that the user's request is being processed (s8.2). The advertisement display program 43 determines whether an advertisement is stored in the memory 42 (step s8.3). If so, the advertisement 64 is displayed in conjunction with the wait icon 63 (step s8.4).

The browser program 40 then requests the desired page from the server via the advertisement client program 41 (step s8.5). The device then waits (step s8.6) until the content arrives or the user selects a link 65 in the advertisement display. If the content arrives (step s8.7), then the new page 66 is displayed (step s8.8) and the process ends (step s8.9), until the user requests new content again.

If no content arrives, but the user selects a link 65 in the advertisement page (step s8.10), then the browser program 40 requests the link page 67 (s8.11). The device then waits (step s8.12), with the advertisement page displayed, until the link page has been downloaded and replaces the current display (step s8.13).

Of course, depending on the available memory, a number of advertisements may be stored at the device for subsequent display. This may, for example, include a selection of advertisements applicable to the user's location. The advertisements may be displayed in accordance with the rotation schedule specified by the user, or based on some other criteria. For example, if advertisements are encoded with position coordinates, a mobile device having GPS tracking capability could select an advertisement relating to a location closest to the present position of the device.

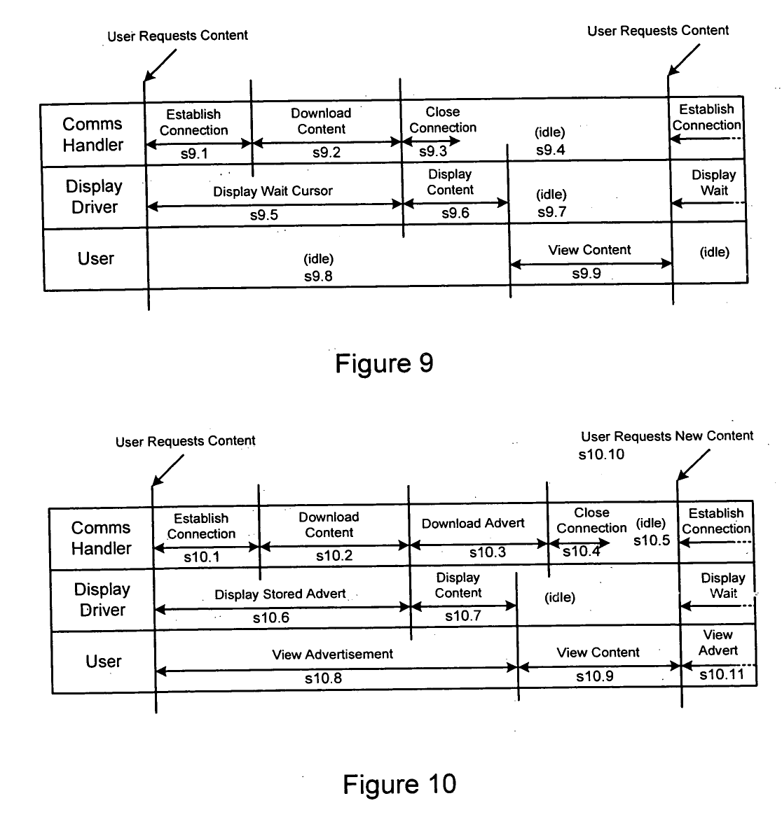

The difference between the system according to the invention and a conventional system is explained below with reference to FIGS. 9 and 10.

FIG. 9 shows a timing diagram for the behaviour of the mobile device 4 when downloading content in a conventional system.

The diagram shows the activity carried out by each of a communications handler 12, the display driver 13 and the user.

When the user requests a content page, the communications handler 12 establishes a connection to the server 2 (step s9.1). It then downloads content (step s9.2). The connection is then closed (step s9.3) and the remaining time is idle time (step s9.4), until the next connection is initiated.

In relation to the display of the mobile device, during the time that the connection is being established and the content is being downloaded, the display driver 13 drives the display to show a wait cursor, for example an hourglass icon (step s9.5). Once the content has been received, the display driver 13 loads the content to the display (step s9.6). Once it has finished driving the display, the driver is idle (step s9.7). In the conventional system, the user has idle time (step s9.8) until the desired content appears on the display at the end of step s9.6, at which time the user is able to view the content (step s9.9).

FIG. 10 shows a timing diagram for the behaviour of the mobile device 4 when downloading content in a system according to the invention.

As with the conventional system, when the user requests a content page, the communications handler 12 establishes a connection to the server 2 (step s10.1). It then downloads content (step s10.2). In contrast to the conventional system, immediately after downloading the content, the communications handler 12 downloads an advertisement (step s10.3). After the advertisement has finished downloading, the connection is closed (step s10.4) and the remaining time is idle time (step s10.5), until the next connection is initiated.

In relation to the display of the mobile device, during the time that the connection is being established and content downloaded, the additional content display program 43 retrieves an advertisement from the mobile device memory 42 and causes the display driver to display the advertisement (step s10.6). When the desired content is received, the display driver is then driven to load the desired content to the display (step s10.7). During this entire period (step s10.8), the user is able to view the advertisement, which is preferable to viewing a wait cursor.

Once the display driver has finished loading the content to the display at the end of step s10.7, the user is then seamlessly switched to viewing the content (step s10.9). When the user requests new content (step s10.10), a previously downloaded advertisement is again displayed (step s10.11). From a user point of view, there is therefore no idle time throughout the entire viewing experience at step s10.8, s10.9 and s10.11, so considerably enhancing the viewing experience.

In addition, the user is not inconvenienced by additional delay while the advertisement or supplementary information is downloaded. The content that the user requests is displayed as soon as it is received, which is what the user wants. Once displayed the user reads the content. During this reading time, the mobile device is otherwise idle, so enabling processing of the advertisement or other supplementary information without interfering with the user experience.

In another embodiment of the invention, if a stored advertisement is displayed and has an associated URL, the browsing computer program displays a soft label for a phone key that, when pressed, will redirect the browser to that URL. This URL will normally contain additional information about the product being advertised or allow the user to purchase the product.

If supplementary information, such as search results, are being displayed, the browsing computer program allows the user to select a link using either the up and down keys or a pointer if the device has a touch screen. When clicked, the browsing session is redirected to the new content.

When the page content is returned to the phone or device, and assuming the user has not clicked on links as above, the browser removes the advertisement or supplementary information and waiting icon, and displays the new content, continuing the browsing session with no interruption.

In a further embodiment of the invention, a downloadable computer program runs on the mobile phone or device, which allows users to view information, similar to a magazine. As the user moves from page to page, while the content of the next page is being downloaded to the device, a stored advertisement is displayed. A clearly-visible hour-glass or other appropriate waiting icon is also displayed. The computer program displays a soft label for a phone key that, when pressed, will redirect the browser to that URL. This URL will normally contain additional information about the product being advertised or allow the user to purchase the product.

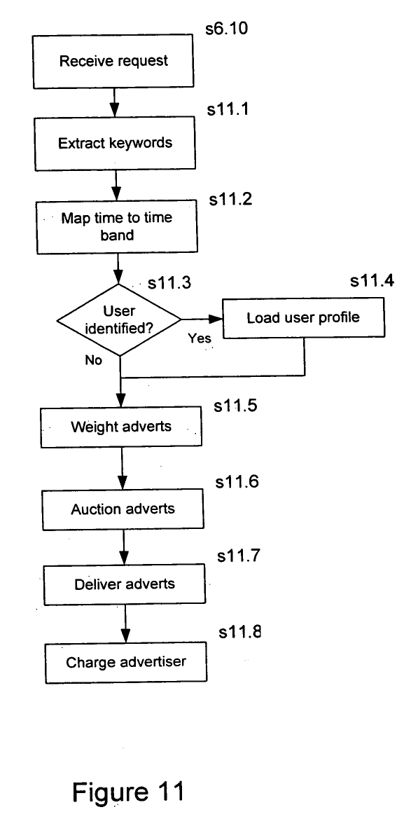

FIG. 11 explains how an advertisement is generated when a request for the advertisement is received, at step s6.10 in FIG. 6.

The advertisement generator receives the request from the additional content server (step s6.10). The request specifies some or all of the following elements: the page content being served, the approximate location (if known) of the mobile device, for example, as calculated by the mobile network, the time of day at the mobile device (or at the server if the time at the mobile device is not known), and the capabilities of the mobile device. These capabilities can include, but are not limited to, the speed of the connection to the mobile device, the screen size and colour depth, video formats accepted, audio formats accepted and so on.

The page content is first analysed to extract keywords (step s11.1). Some keywords may be specified using meta-syntax with the WAP or XHTML content. Other keywords are identified by analysing the textual content and eliminating common words. The method and system are able to operate on a wide variety of languages.

The time of day is then mapped into one of a number of pre-determined time bands, including but not limited to, breakfast, morning, lunchtime, afternoon, dinner time, early evening, late evening, night, late night and early morning (step s11.2).

If the user identity is known (step s11.3), the corresponding user profile is loaded from the user profile database 25 (step s11.4). The user identity is for example provided as part of initial customer registration for the service and stored on the phone as a cookie, which is sent from the phone when a request for new content is made.

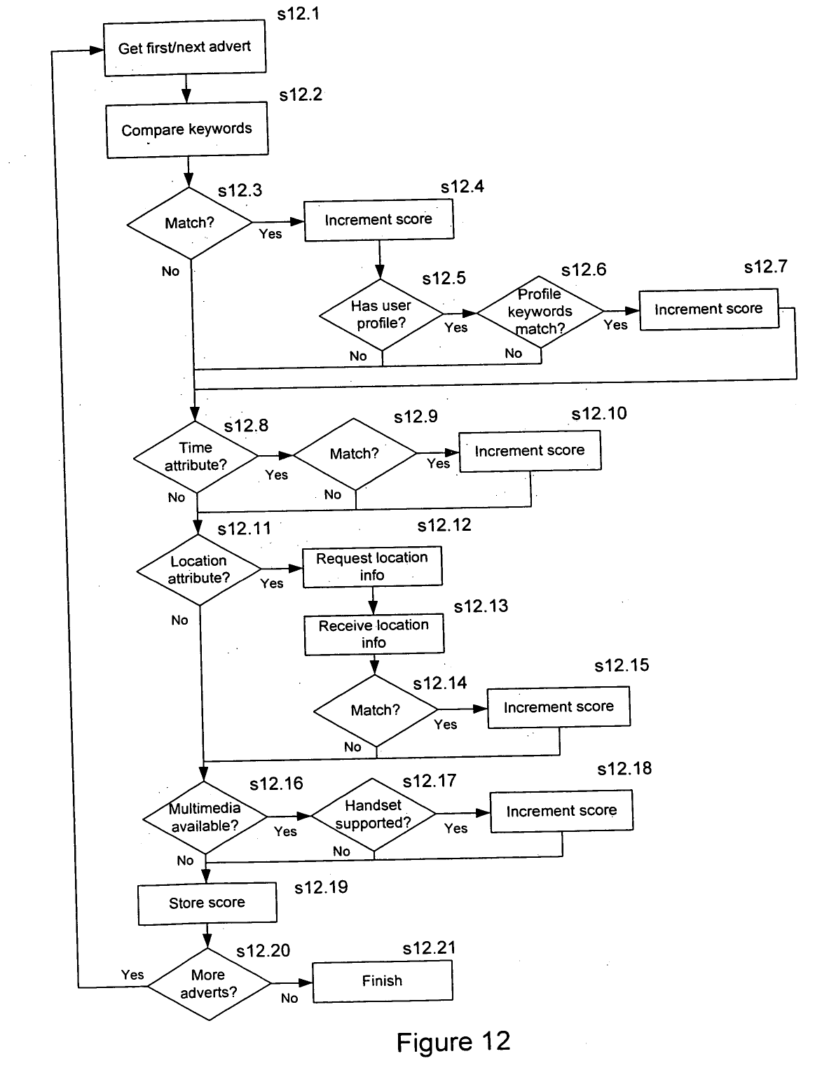

The registered advertisements are then retrieved from the advertisement database and weighted (step s11.5). The weighting for each advertisement takes into account how each element matches against the stored attributes of the advertisement, such as keywords, and results in a score for the advertisement, that evaluates the relevance of the advertisement to the user. For example, a fast-food vendor keys an advertisement to meal times, and links in the location, so that an advert corresponding to a person browsing neat an outlet at a meal time would get a high score. Another example would be someone browsing movie information in the early evening, resulting in a high score to adverts from movie theaters with nearby presence. The weighting process will be described in more detail in FIG. 12.

After weighting, the advertisements are auctioned between the advertisers (step s11.6). The automatic auction system identifies the highest paying advertiser with available budget, matching scores and payment limits registered with the advert. It may be that one advertiser may pay more for a lower score than a less generous price on a higher-scoring advertisement. In this case, the lower score will be chosen.

Advertisements with no attributes specified will have a zero score and will be displayed as “run of site” advertisements, that is, they will be displayed when there is nothing more specific to show. When this happens, the highest-paying advertisement where the advertiser has available budget is picked.

Once the auction mechanism has selected the highest-paying, best matching advert, it is delivered to the additional content server program (step s11.7) for transmission to the mobile phone or handset. In the case of a dynamic advert, this is created in accordance with the specified mechanism prior to delivery, for example by invoking the dynamic content generator 31 running in the advertiser's computer system. The charge for the impression is then deducted from the account of the advertiser (step s11.8).

The advertisement weighting process will now be explained in detail with reference to FIG. 12.

Each advertisement is retrieved from the advertisement database (step s12.1). The retrieved keywords are compared with the keywords associated with the advertisement (step s12.2). If there is a match with a given keyword (step s12.3), the score for the given advertisement is incremented (step s12.4). The process is repeated for all keywords.

If there is a match at step s12.3, the system also determines whether a user profile is loaded (step s12.5), and determines the degree of match to this profile, for example, by matching user profile keywords (step s12.6), and increments the score if a match is found (step s12.7). For example, an advert targeted at males aged 25-34 who like sport will score highly if the user profile matches this.

If there is a time attribute (step s12.8), the time is matched against the predetermined time bands (step s12.9) and the score incremented if a match is found (step s12.10).

If there is a location attribute (step s12.11), location information is requested from the advertiser's location verification system 30 (step s12.12), this is received (step s12.13) and the user's location is matched against the location information (step s12.14). The advert score is again incremented if a match is found (step s12.15). For example, approximate location information received from the mobile network is passed to the advertiser's location verification system 30. This works out the nearest location associated with the advertiser, for example a shop or branch, and returns the location. The matching algorithm determines a score based on how close the advertiser's location is to the user's location, for example incrementing the score if the advertiser's location falls within a certain radius of the user's location.

The score may be further refined by matching the device capability against the available media. For example, the system checks if an advertisement has multimedia content available, such as video content (step s12.16). If so, and if the user's handset supports the media type (step s12.17), for example, the user has a mobile phone with a fast connection and with video capability, then the advert score is incremented (step s12.18).

The overall score for the advertisement is then stored (step s12.19) and the next advertisement processed (step s12.20, 12.1). If there are no further advertisements, the process terminates (step s12.21) and returns to the auctioning step s11.6 in FIG. 11.

It will be appreciated by the skilled person that the above weighting process is an example of the way in which adverts may be weighted, but this is not limiting and numerous other examples of weighting processes would be apparent to a person skilled in the art. For example, if a user has implemented a whitelist of preferred brands, additional weighting can be applied to advertisements for brands that appear on the whitelist.

In addition to elective preferences, embodiments of the present invention may employ filtering of the suitability of additional content based on the factors such as the age of the user determined from the initial customer registration. Such filtering can be implemented at the server or the device level or both.

While the above invention has been described in terms of unobtrusively downloading advertisements during a request for new content, it will be apparent to the skilled person that such unobtrusive downloading is possible at other times. For example, downloading may occur automatically during periods of network update, as happens periodically on GSM networks, as well as during cell handover, when a cellular phone moves from one geographical coverage cell to another. To maintain targeting of the content, the additional content to be downloaded may be chosen based on a user's historic usage patterns, or may be based on elected choices of interest made by a user at a previous date, or in the case of cell handover, may be selected based on location.

Furthermore, while the above invention has been primarily described with the additional content selection software disposed at the server side, it will be apparent that aspects of this software can be implemented at the mobile device. For example, even after pages of additional content have been downloaded to the local content cache in the mobile device, the mobile device may make a decision as to which of the pages are to be displayed or discarded based on local attributes, such as device location or user preferences.

Although primarily described in terms of software modules, embodiments of the invention may be implemented in any combination of hardware and software and may be embodied on computer readable media.

The above invention has been described with a number of exemplary embodiments. However, it will be appreciated by the skilled person that these embodiments are not limiting and that the invention can be implemented in numerous different ways still falling within the spirit and scope of the appended claims and their equivalents.

1. A method of delivering targeted content to a mobile device, the method comprising:
receiving a request for content from a mobile device, the request being associated with at least one parameter;
automatically selecting additional content in dependence on the at least one parameter; and
providing the additional content to the mobile device in addition to the requested content.

2. A method according to claim 1, further comprising selecting additional content in dependence on the requested content.

3. A method according to claim 2, comprising analysing the requested content to determine at least one attribute and comparing the determined attribute with predetermined attributes of the additional content.

4. A method according to claim 3, wherein the determined attribute comprises keywords.

5. A method according to claim 1, wherein the at least one parameter includes a location of the mobile device.

6. A method according to claim 1, wherein the at least one parameter includes a time at which the request is made.

7. A method according to claim 1, wherein the at least one parameter includes a parameter selected from a user profile associated with a user of the mobile device.

8. A method according to claim 1, wherein the at least one parameter includes a plurality of parameters defining capabilities of the mobile device.

9. A method according to claim 1, comprising calculating a score for the additional content in dependence on the at least one parameter.

10. A method according to claim 9, wherein calculating a score comprises incrementing the score when the at least one parameter matches a predetermined attribute associated with the additional content.

11. A method according to claim 9, comprising selecting the additional content based on the highest price that an advertiser is prepared to pay for the score.

12. A method according to claim 1, comprising selectively weighting the additional content based on a prior selection by a user of content of interest.

13. A method according to claim 1, comprising excluding content from selection based on a prior selection by a user of excluded content.

14. A method according to claim 1, wherein the additional content comprises a plurality of segments of additional content, the method further comprising specifying the order in which the plurality of segments ate to be displayed to the user.

15. A method according to claim 1, wherein the additional content comprises a plurality of segments of additional content, the method further comprising specifying a presentation style for each segment of additional content.

16. A method according to claim 1, wherein the additional content comprises an advertisement.

17. A method according to claim 1, wherein the additional content comprises a voucher entitling a user of the mobile device to a promotional offer at a location associated with a provider of the additional content.

18. A method according to claim 17, wherein the voucher is displayable on a screen of the mobile device in the form of a bar code.

19. A method of delivering content to a mobile device, the method comprising:
receiving a request for content to be displayed at the mobile device;
selecting additional content to be sent to the mobile device with the requested content; and
providing the additional content to the mobile device immediately after the requested content.

20. A method according to claim 19, comprising displaying the requested content when it is received at the mobile device.

21. A method according to claim 19, wherein the mobile device includes a memory, further comprising storing the additional content in the memory when it is received at the mobile device.

22. A method according to claim 21, comprising reading the stored content from the memory and displaying it when the mobile device sends a request for new content.

23. A method according to claim 19, wherein the additional content comprises an advertisement.

24. A method according to claim 19, wherein selecting the additional content comprises:
a) scoring a plurality of pages of additional content based on a comparison with the request for content; and
b) selecting from the plurality of pages those pages that have scored relatively highly.

25. A method according to claim 19, wherein selecting the additional content comprises selecting the content based on behaviour derived from historic usage patterns.

26. A method of operating a mobile device, comprising:
requesting content from a remote content provider;
determining if additional content is stored at the device; and
if additional content is stored at the device, displaying content selected from the additional content while waiting for the requested content to be delivered.

27. A method according to claim 26, wherein the additional content comprises at least one advertisement.

28. A method according to claim 27, wherein the additional content comprises a plurality of advertisements, the advertisements being displayed in accordance with a rotation schedule specified by the advertiser.

29. A method according to claim 27, wherein the at least one advertisement is associated with a URL, further comprising linking to the URL in response to a user action.

30. A system for delivering targeted content to a local content cache in a mobile device, the mobile device operating in a local context, the system comprising:
a server computer configured to rank a plurality of pages of additional content using weighting algorithms to determine relevance of each of the plurality of pages of additional content to the local context of the mobile device;
the server computer being configured to deliver at least one page of additional content to the device for storage at the device, the page being ranked relatively highly in comparison to others of the plurality of pages; and
the mobile device being configured to store the at least one page of additional content in the local content cache.

31. A system according to claim 30, wherein the mobile device is arranged to calculate the most relevant additional content for the local content cache based on local attributes.

32. A mobile device having a content cache, comprising:
a communications module configured to request content from a remote content provider;
a content cache reading module configured to determine if additional content is stored at the device; and
a display driver, the display driver being configured, if additional content is stored at the device, to display content selected from the additional content while waiting for the requested content to be delivered.

33. A mobile device according to claim 32, wherein the communications module is configured to receive content cache updates during a cell handover procedure.

34. A mobile device according to claim 32, wherein the communications module is configured to receive content cache updates during a network update procedure.
